(19) United States
(12) Patent Application Publication
(10) Pub. No.: US 2011/0143107 A1
(43) Pub. Date: Jun. 16, 2011

(54) PRODUCTION OF METALLIZED SURFACES, METALLIZED SURFACE AND USE THEREOF

(75) Inventors: Christian STEINIG-NOWAKOWSKI, Deidesheim (DE); Ralf Nörenberg, Ludwigshafen (DE); Sorin Ivanovici, Heidelberg (DE); Peter Breyer, Maxdorf (DE); Jürgen Reichert, Limburgerhof (DE)

(73) Assignee: BASF SE, Ludwigshafen (DE)

(21) Appl. No.: 12/966,621

(22) Filed: Dec. 13, 2010

Related U.S. Application Data
(60) Provisional application No. 61/286,044, filed on Dec. 14, 2009.

(30) Foreign Application Priority Data
Dec. 14, 2009 (EP) 09179120.2

(51) Int. Cl. B32B 15/14; B05D 1/36; B05D 1/38; B05D 3/00; B05D 3/14; B32B 15/04; C09D 1/00; B82Y 99/00; B82Y 30/00

(52) U.S. Cl. 428/196; 427/205; 427/457; 442/72; 428/206; 106/31.95; 977/742; 977/734

(57) ABSTRACT

A process for producing a metallized textile surface comprises
(A) applying a formulation comprising at least one metal powder (a) as a component patternedly or uniformly,
(B) depositing a further metal on the textile surface,
(C) applying a further layer comprising carbon in the form of carbon black or carbon nanotubes or graphene.

The present invention relates to a process for producing a metallized surface, which process comprises
(A) applying a formulation comprising at least one metal powder (a) as a component patternedly or uniformly,
(B) depositing a further metal on the textile surface and
(C) applying a further layer comprising carbon in the form of carbon black or carbon nanotubes or graphene.

The present invention further relates to surfaces produced by following the process of the present invention. The present invention further relates to the use of metallized surfaces.

The production of metallized sheet materials is a field of colossal potential for growth. Metallized sheet materials, for example foils and metallized textiles, find numerous fields of application. Especially metallized textile sheet materials can be used for example as heating mantles, also as fashion articles, for example for luminous textiles, or for producing textiles useful in medicine including prophylaxis, for example for monitoring organs and their function. Metallized textile sheet materials can further be used to screen off electromagnetic radiation.

Especially existing processes for producing such metallized textiles, however, are still very costly, inconvenient and inflexible. Specific equipment is needed and it is not possible to use traditional apparatus such as conventional weaving looms for example. It is known for example to incorporate metal threads in textile. More particularly, it is known to apply carbon, silver or steel fibers to woven fabrics or to interweave silver or copper fibers. However, in many cases it is not possible to combine for example copper threads and polyester threads satisfactorily with each other to form wovens, since specific weaving looms are needed. In addition, it has to be clear from the start of the manufacturing operation in which form metal is to be incorporated. A flexible approach to customer wishes is thus not possible.

WO 2007/074090 discloses a process for producing metallized textiles. The disclosed process provides simple production of heatable textiles for example. It proceeds from textile onto which a metal powder, preferably a carbonyl iron powder, is printed. A further step comprises metallizing, for example by electroplating. Complicated metallized patterns are extremely easy to generate.

WO 2008/101917 discloses a process for producing metallized textiles which are provided with current-generating or current-consuming articles in an additional operation.

Both disclosed methods do provide an extremely simple and inexpensive way to metallize textiles. In some cases, however, disadvantages are also observed. When there is a break or kink in a printed electric current track, hot spots are found to appear due to the build-up of electrical resistance. Such hot spots can represent a fire risk, since breaks and kinks of tracks are in many cases unavoidable when metallized textiles are put to prolonged use and mechanically stressed.

Disadvantages of this kind are also observed in the case of substrates other than textile. Hot spots can also be undesirable in metallized polymeric foils.

The present invention has for its object to provide a process for producing metallized textiles and also other metallized substrates that do not form hot spots in prolonged use. The present invention further has for its object to provide metallized textiles which are simple to produce, yet do not form hot spots under prolonged mechanical stress.

We have found that this object is achieved by the process defined at the beginning.

The present process for producing a metallized surface comprises
(A) applying a formulation comprising at least one metal powder (a) as a component patternedly or uniformly,
(B) depositing a further metal on the textile surface, and
(C) applying a further layer comprising carbon in the form of carbon black or carbon nanotubes or graphene.

The process of the present invention is carried out by providing a surface of a substrate which can be made of any preferably acid-stable materials. Manually bendable substrates for example are suitable, examples being polymeric foils such as foils composed of polyethylene, polypropylene, polystyrene and/or copolymers of polystyrene, for example ABS and SAN, and also polyvinyl chloride.

In one embodiment, the surface of the substrate is a textile surface, herein also referred to as textile for short, examples being formed-loop knits, ribbons, film tapes, knitwear or preferably wovens or nonwovens. Textiles for the purposes of the present invention can be stiff or preferably flexible. Preferably, the textiles can be bent one or more times by hand for example without it being possible to detect a visual difference between before the bending and after the return from the bent state.

Textiles for the purposes of the present invention can be of natural fibers or synthetic fibers or mixtures of natural fibers and synthetic fibers. Useful natural fibers include for example wool, flax and preferably cotton. Useful synthetic fibers include for example polyamide, polyester, modified polyester, polyester blend fabric, polyamide blend fabric, polyacrylonitrile, triacetate, acetate, polycarbonate, polypropylene, polyvinyl chloride, polyester microfibers, preference being given to polyester and blends of cotton with synthetic fibers, particularly blends of cotton and polyester.

Textile for the purposes of the present invention can be untreated or preferably pretreated. Examples of pretreatment methods are bleaching, dyeing, coating and finishing, for example crease-resist finishing.

A first operation, step (A), comprises applying to textile patternedly or uniformly a formulation comprising as a component at least one metal powder (a), the metal in question preferably having a more strongly negative standard potential than hydrogen in the electrochemical series of the elements.

The formulation of step (A) is preferably a liquid formulation and more preferably an aqueous formulation. The continuous phase of an aqueous formulation comprises at least 50%, preferably at least 66% and more preferably at least 90% of water as solvent. In one advantageous embodiment of the present invention, the continuous phase of an aqueous formulation comprises no organic solvent.

In one embodiment of the present invention, formulation of step (A) comprises from 1% to 70% by weight of metal powder (a).

In one embodiment of the present invention, the metal underlying metal powder (a) has a more strongly negative standard potential in the electrochemical series of the elements than hydrogen. Metal powder (a) whose metal preferably has a more strongly negative standard potential than hydrogen in the electrochemical series of the elements is herein also referred to as metal powder (a) for short.

Metal powder (a) is preferably one or more metals in powdery form, the metal or metals preferably being more noble than hydrogen. Preference for use as metal powder (a) is given to silver, tin, nickel, zinc or alloys of one or more of the aforementioned metals.

In one embodiment of the present invention, the particles of metal powder (a) have an average diameter in the range from 1 to 250 nm, preferably 10 to 100 nm, and more preferably 15 to 25 nm.

In one embodiment of the present invention, the particles of metal powder (a) have an average diameter in the range from 0.01 to 100 μm, preferably from 0.1 to 50 μm and more preferably from 1 to 10 μm, determined by laser diffraction measurement, for example using a Microtrac X100.

In one embodiment of the process of the present invention, substrate and particularly textile is printed in step (A) with a printing formulation, preferably an aqueous printing formulation, comprising at least one metal powder (a), the metal powder in question preferably having a more strongly negative standard potential than hydrogen in the electrochemical series of the elements.

Examples of printing formulations are printing inks, for example gravure printing inks, offset printing inks, liquid printing inks such as for example liquid inks for the Valvoline process and preferably print pastes, preferably aqueous print pastes.

Metal powder (a) can be selected for example from pulverulent Zn, Ni, Cu, Sn, Co, Mn, Fe, Mg, Pb, Cr and Bi, for example pure or as a mixture or in the form of alloys of the recited metals with each other or with other metals. Examples of useful alloys are CuZn, CuSn, CuNi, SnPb, SnBi, SnCu, NiP, ZnFe, ZnNi, ZnCo and ZnMn. Preferred metal powders (a) which can be used comprise just one metal, particular preference being given to iron powder and copper powder and very particular preference being given to iron powder.

In one embodiment of the present invention, metal powder (a) has an average particle diameter in the range from 0.01 to 100 μm, preferably in the range from 0.1 to 50 μm and more preferably in the range from 1 to 10 μm (determined by laser diffraction measurement, for example using a Microtrac X100).

In one embodiment, metal powder (a) is characterized by its particle diameter distribution. For example, the d₁₀ value can be in the range from 0.01 to 5 μm, the d50 value can be in the range from 1 to 10 μm and the d₉₀ value can be in the range from 3 to 100 μm, subject to the condition: d₁₀<d₅₀<d₉₀. Preferably, no particle has a diameter greater than 100 μm.

Metal powder (a) can be used in passivated form, for example in an at least partially coated form. Examples of useful coatings include inorganic layers such as oxide of the metal in question, SiO₂ or SiO₂.aq or phosphates for example of the metal in question.

The particles of metal powder (a) can in principle have any desired shape in that for example acicular, lamellar or spherical particles can be used, preference being given to spherical and lamellar particles.

It is particularly preferable to use metal powders (a) having spherical particles, preferably predominantly having spherical particles, most preferably so-called carbonyl iron powders having spherical particles.

The production of metal powders (a) is known per se. For example, common commercial goods can be used or metal powders (a) produced by processes known per se, for example by electrolytic deposition or chemical reduction from solutions of salts of the metals in question or by reduction of an oxidic powder for example by means of hydrogen, by spraying or jetting a molten metal, in particular into cooling media, for example gases or water.

Particular preference is given to using such metal powder (a) as was produced by thermal decomposition of iron pentacarbonyl, herein also referred to as carbonyl iron powder.

The production of carbonyl iron powder by thermal decomposition of, in particular, iron pentacarbonyl Fe(CO)₅ is described for example in Ullmann's Encyclopedia of Industrial Chemistry, 5^{th} Edition, Volume A14, page 599. The decomposition of iron pentacarbonyl can be effected for example at atmospheric pressure and for example at elevated temperatures, for example in the range from 200 to 300° C., for example in a heatable decomposer comprising a tube of heat-resistant material such as quartz glass or V2A steel in a preferably vertical position, the tube being surrounded by heating means, for example consisting of heating tapes, heating wires or a heating mantle through which a heating medium flows.

The average particle diameter of carbonyl iron powder can be controlled within wide limits via the process parameters and reaction management in relation to the decomposition stage, and is in terms of the number average in general in the range from 0.01 to 100 μm, preferably in the range from 0.1 to 50 μm and more preferably in the range from 1 to 8 μm.

Metal powder (a) can in one embodiment of step (A) be printed such that the particles of metal powder come to lie so close together that they are already capable of conducting electric current. In another embodiment of step (A), metal powder (a) can be printed such that the particles of metal powder (a) are so far apart from each other that they are not capable of conducting electric current.

Preferably, metal powder (a) is applied in step (A) such that an interdigital structure is generated. An interdigital structure is a pattern wherein the elements form an interlocking-finger design without touching.

In one embodiment of the present invention, formulation of step (A) may comprise a binder (b), preferably at least one aqueous dispersion of at least one film-forming polymer, for example polyacrylate, polybutadiene, copolymers of at least one vinylaromatic and at least one conjugated diene and optionally further comonomers, for example styrene-butadiene binders. Further suitable binders are selected from polyurethane, preferably anionic polyurethane, or ethylene-(meth)acrylic acid copolymer.

Useful binder (b) polyacrylates for the purposes of the present invention are obtainable for example by copolymerization of at least one C₁-C₁₀-alkyl(meth)acrylate, for example methyl acrylate, ethyl acrylate, n-butyl acrylate, n-butyl methacrylate, 2-ethylhexyl acrylate, with at least one further comonomer, for example with a further C₁-C₁₀-alkyl(meth)acrylate, (meth)acrylic acid, (meth)acrylamide, N-methylol(meth)acrylamide, glycidyl(meth)acrylate or a vinylaromatic compound such as styrene for example.

Useful binder (b) polyurethanes for the purposes of the present invention, which are preferably anionic, are obtainable for example by reaction of one or more aromatic or preferably aliphatic or cycloaliphatic diisocyanates with one or more polyesterdiols and preferably one or more hydroxy carboxylic acids, for example hydroxyacetic acid, or preferably dihydroxy carboxylic acids, for example 1,1-dimethylolpropionic acid, 1,1-dimethylolbutyric acid or 1,1-dimethylolethanoic acid, or of a diamino carboxylic acid, for example the Michael addition product of ethylenediamine onto (meth)acrylic acid.

Particularly useful binder (b) ethylene-(meth)acrylic acid copolymers are obtainable for example by copolymerization of ethylene, (meth)acrylic acid and if appropriate at least one further comonomer such as for example C₁-C₁₀-alkyl (meth)acrylate, maleic anhydride, isobutene or vinyl acetate, preferably by copolymerization at temperatures in the range from 190 to 350° C. and pressures in the range from 1500 to 3500 bar and preferably in the range from 2000 to 2500 bar.

Particularly useful binder (b) ethylene-(meth)acrylic acid copolymers may for example comprise up to 90% by weight of interpolymerized ethylene and have a melt viscosity v in the range from 60 mm²/s to 10 000 mm²/s, preferably in the range from 100 mm²/s to 5000 mm²/s, measured at 120° C.

Particularly useful binder (b) ethylene-(meth)acrylic acid copolymers may for example comprise up to 90% by weight of interpolymerized ethylene and have a melt flow rate (MFR) in the range from 1 to 50 g/10 min, preferably in the range from 5 to 20 g/10 min and more preferably in the range from 7 to 15 g/10 min, measured at 160° C. under a load of 325 g in accordance with EN ISO 1133.

Particularly useful binder (b) copolymers of at least one vinylaromatic with at least one conjugated diene and if appropriate further comonomers, for example styrene-butadiene binders, comprise at least one ethylenically unsaturated carboxylic acid or dicarboxylic acid or a suitable derivative, for example the corresponding anhydride, in interpolymerized form. Particularly suitable vinylaromatics are para-methylstyrene, α-methylstyrene and especially styrene. Particularly suitable conjugated dienes are isoprene, chloroprene and in particular 1,3-butadiene. Particularly suitable ethylenically unsaturated carboxylic acids or dicarboxylic acids or suitable derivatives thereof are (meth)acrylic acid, maleic acid, itaconic acid, maleic anhydride or itaconic anhydride, to name just some examples.

In one embodiment of the present invention, particularly suitable binder (b) copolymers of at least one vinylaromatic with at least one conjugated diene and if appropriate further comonomers comprise in interpolymerized form:
19.9% to 80% by weight of vinylaromatic,
19.9% to 80% by weight of conjugated diene,
0.1% to 10% by weight of ethylenically unsaturated carboxylic acid or dicarboxylic acid or a suitable derivative, for example the corresponding anhydride.

In one embodiment of the present invention, binder (b) has a dynamic viscosity at 23° C. in the range from 10 to 100 dPa·s and preferably in the range from 20 to 30 dPa·s, determined for example by rotary viscometry, for example using a Haake viscometer.

Formulation of step (A) may further comprise one or more additives, for example one or more emulsifiers or one or more thickeners or one or more fixers. Emulsifiers, thickeners, fixers and any further additives to be used are described hereinbelow.

In one embodiment of the present invention, formulation of step (A) has a solids content in the range from 1% to 90% and preferably in the range from 30% to 80%.

In one embodiment of the present invention, sufficient formulation is applied in step (A) for the coverage of substrate and especially of textile with metal powder (a) to be in the range from 20 to 200 g/m² and preferably in the range from 40 to 80 g/m².

The application of formulation from step (A) can be followed by curing, for example photochemically or preferably by thermal treatment, in one or two or more steps. When two or more steps of thermal treatment are carried out, two or more steps can be carried out at the same temperature or preferably at different temperatures.

Treating for the purposes of curing can be for example at temperatures in the range from 50 to 200° C.

Treating for the purposes of curing can be for example for a period from 10 seconds to 15 minutes, preferably 30 seconds to 10 minutes.

Particular preference is given to treating in a first step for thermal treatment at temperatures in the range of for example 50 to 110° C. for a period of 30 seconds to 3 minutes and in a second step subsequently at temperatures in the range from 130° C. to 200° C. for a period of 30 seconds to 15 minutes.

It will be appreciated that the temperature at which the thermal treatment is carried out is adapted to the melting point of substrate.

Each individual step for the purposes of curing can be carried out in equipment known per se, for example in atmosphere drying cabinets, tenters or vacuum drying cabinets.

In one embodiment of the present invention, step (A) utilizes a preferably aqueous printing formulation comprising:
(a) at least one metal powder wherein the metal in question preferably has a more strongly negative standard potential than hydrogen in the electrochemical series of the elements, preference being given to carbonyl iron powder,
(b) at least one binder,
(c) at least one emulsifier, which may be anionic, cationic or preferably nonionic,
(d) optionally at least one rheology modifier.

Printing formulations from step (A) may comprise at least one binder (b), preferably at least one aqueous dispersion of at least one film-forming polymer, for example polyacrylate, polybutadiene, copolymers of at least one vinylaromatic and at least one conjugated diene and optionally further comonomers, for example styrene-butadiene binders. Further suitable binders (b) are selected from polyurethane, preferably anionic polyurethane, or ethylene-(meth)acrylic acid copolymer.

Emulsifier (c) may be an anionic, cationic or preferably nonionic surface-active substance.

Examples of suitable cationic emulsifiers (c) are for example a C₆-C₁₈-alkyl-, C₇-C₁₈-aralkyl- or a heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the gemini surfactant N,N′-(lauryldimethyl)ethylenediamine dibromide.

Examples of suitable anionic emulsifiers (c) are alkali metal and ammonium salts of alkyl sulfates (alkyl radical: C₈ to C₁₂), of sulfuric acid monoesters of ethoxylated alkanols (degree of ethoxylation: 4 to 30, alkyl radical: C₁₂-C₁₈) and of ethoxylated alkylphenols (degree of ethoxylation: 3 to 50, alkyl radical: C₄-C₁₂), of alkylsulfonic acids (alkyl radical: C₁₂-C₁₈), of alkylarylsulfonic acids (alkyl radical: C₉-C₁₈) and of sulfosuccinates such as for example sulfosuccinic mono- or diesters. Preference is given to aryl- or alkyl-substituted polyglycol ethers and also to substances described in U.S. Pat. No. 4,218,218, and homologs with y (from the formulae of U.S. Pat. No. 4,218,218) in the range from 10 to 37.

Particular preference is given to nonionic emulsifiers (c) such as for example singly or preferably multiply alkoxylated C₁₀-C₃₀ alkanols, preferably with three to one hundred mol of C₂-C₄-alkylene oxide, in particular ethoxylated oxo process or fatty alcohols.

Examples of particularly suitable multiply alkoxylated fatty alcohols and oxo process alcohols are
n-C₁₈H₃₇O—(CH₂CH₂O)₈₀—H, n-C₁₈H₃₇O—(CH₂CH₂O)₇₀—H, n-C₁₈H₃₇O—(CH₂CH₂O)₆₀—H, n-C₁₈H₃₇O—(CH₂CH₂O)₅₀—H, n-C₁₈H₃₇O—(CH₂CH₂O)₂₅—H, n-C₁₈H₃₇O—(CH₂CH₂O)₁₂—H, n-C₁₆H₃₃O—(CH₂CH₂O)₈₀—H, n-C₁₆H₃₃O—(CH₂CH₂O)₇₀—H, n-C₁₆H₃₃O—(CH₂CH₂O)₆₀—H, n-C₁₆H₃₃O—(CH₂CH₂O)₅₀—H, n-C₁₆H₃₃O—(CH₂CH₂O)₂₅—H, n-C₁₆H₃₃O—(CH₂CH₂O)₁₂—H, n-C₁₂H₂₅O—(CH₂CH₂O)₁₁—H, n-C₁₂H₂₅O—(CH₂CH₂O)₁₈—H, n-C₁₂H₂₅O—(CH₂CH₂O)₂₅—H, n-C₁₂H₂₅O—(CH₂CH₂O)₅₀—H, n-C₁₂H₂₅O—(CH₂CH₂O)₈₀—H, n-C₃₀H₆₁O—(CH₂CH₂O)₈—H, n-C₁₀H₂₁O—(CH₂CH₂O)₉—H, n-C₁₀H₂₁O—(CH₂CH₂O)₇—H, n-C₁₀H₂₁O—(CH₂CH₂O)₅—H, n-C₁₀H₂₁O—(CH₂CH₂O)₃—H,
   and mixtures of the aforementioned emulsifiers, for example mixtures of
n-C₁₈H₃₇—(CH₂CH₂O)₅₀—H and n-C₁₆H₃₃O—(CH₂CH₂O)₅₀—H,
   the indices each being number averages.

In one embodiment of the present invention, printing formulations, especially aqueous printing formulations, used in step (A) can comprise at least one rheology modifier (d) selected from thickeners (d1) and viscosity reducers (d2).

Suitable thickeners (d1) are for example natural thickeners or preferably synthetic thickeners. Natural thickeners are such thickeners as are natural products or are obtainable from natural products by processing such as purifying operations for example, in particular extraction. Examples of inorganic natural thickeners are sheet silicates such as bentonite for example. Examples of organic natural thickeners are preferably proteins such as for example casein or preferably polysaccharides. Particularly preferred natural thickeners are selected from agar agar, carrageenan, gum arabic, alginates such as for example sodium alginate, potassium alginate, ammonium alginate, calcium alginate and propylene glycol alginate, pectins, polyoses, carob bean flour (carubin) and dextrins.

Preference is given to using synthetic thickeners selected from generally liquid solutions of synthetic polymers, in particular acrylates, in for example white oil or as aqueous solutions, and from synthetic polymers in dried form, for example spray-dried powders. Synthetic polymers used as thickeners (d1) comprise acid groups, which are neutralized with ammonia completely or to a certain percentage. In the course of the fixing operation, ammonia is released, reducing the pH and starting the actual fixing process. The pH reduction necessary for fixing may alternatively be effected by adding nonvolatile acids such as for example citric acid, succinic acid, glutaric acid or malic acid.

Very particularly preferred synthetic thickeners are selected from copolymers of 85% to 95% by weight of acrylic acid, 4% to 14% by weight of acrylamide and 0.01 to not more than 1% by weight of the (meth)acrylamide derivative of the formula I

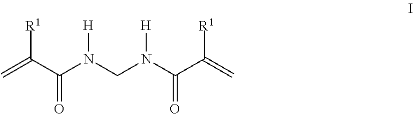

having molecular weights M_{w} in the range from 100 000 to 2 000 000 g/mol, in each of which the R¹ radicals may be the same or different and may represent methyl or hydrogen.

Further suitable thickeners (d1) are selected from reaction products of aliphatic diisocyanates such as for example trimethylene diisocyanate, tetramethylene diisocyanate, hexamethylene diisocyanate or 1,12-dodecane diisocyanate with preferably 2 equivalents of multiply alkoxylated fatty alcohol or oxo process alcohol, for example 10 to 150-tuply ethoxylated C₁₀-C₃₀fatty alcohol or C₁₁-C₃₁ oxo process alcohol.

Suitable viscosity reducers (d2) are for example organic solvents such as dimethyl sulfoxide (DMSO), N-methylpyrrolidone (NMP), N-ethylpyrrolidone (NEP), ethylene glycol, diethylene glycol, butylglycol, dibutylglycol and for example alkoxylated n-C₄-C₈-alkanol free of residual alcohol, preferably singly to 10-tuply and more preferably 3- to 6-tuply ethoxylated n-C₄-C₈-alkanol free of residual alcohol. Residual alcohol refers to the respectively nonalkoxylated n-C₄-C₈-alkanol.

In one embodiment of the present invention, the printing formulation used in step (A) comprises
from 10% to 90% by weight, preferably from 50% to 85% by weight and more preferably from 60% to 80% by weight of metal powder (a),
from 1% to 20% by weight and preferably from 2% to 15% by weight of binder (b),
from 0.1% to 4% by weight and preferably up to 2% by weight of emulsifier (c),
from 0% to 5% by weight and preferably from 0.2% to 1% by weight of rheology modifier (d),
weight % ages each being based on the entire printing formulation used in step (A) and relating in the case of binder (b) to the solids content of the respective binder (b).

One embodiment of the present invention comprises printing in step (A) of the process of the present invention with a printing formulation, which, in addition to metal powder (a) and if appropriate binder (b), emulsifier (c) and if appropriate rheology modifier (d), comprises at least one auxiliary (e). Examples of suitable auxiliaries (e) are hand improvers, defoamers, wetting agents, leveling agents, urea, actives such as for example biocides or flame retardants.

Suitable defoamers are for example siliconic defoamers such as for example those of the formula HO—(CH₂)₃—Si(CH₃)[OSi(CH₃)₃]₂ and HO—(CH₂)₃—Si(CH₃)[OSi(CH₃)₃][OSi(CH₃)₂OSi(CH₃)₃], nonalkoxylated or alkoxylated with up to 20 equivalents of alkylene oxide and especially ethylene oxide. Silicone-free defoamers are also suitable, examples being multiply alkoxylated alcohols, for example fatty alcohol alkoxylates, preferably 2 to 50-tuply ethoxylated preferably unbranched C₁₀-C₂₀ alkanols, unbranched C₁₀-C₂₀ alkanols and 2-ethylhexan-1-ol. Further suitable defoamers are fatty acid C₈-C₂₀-alkyl esters, preferably C₁₀-C₂₀-alkyl stearates, in each of which C₈-C₂₀-alkyl and preferably C₁₀-C₂₀-alkyl may be branched or unbranched.

Suitable wetting agents are for example nonionic, anionic or cationic surfactants, in particular ethoxylation and/or propoxylation products of fatty alcohols or propylene oxide-ethylene oxide block copolymers, ethoxylated or propoxylated fatty or oxo process alcohols, also ethoxylates of oleic acid or alkylphenols, alkylphenol ether sulfates, alkylpolyglycosides, alkyl phosphonates, alkylphenyl phosphonates, alkyl phosphates or alkylphenyl phosphates.

Suitable leveling agents are for example block copolymers of ethylene oxide and propylene oxide having molecular weights Mₙ in the range from 500 to 5000 g/mol and preferably in the range from 800 to 2000 g/mol. Very particular preference is given to block copolymers of propylene oxide-ethylene oxide for example of the formula EO₈PO₇EO₈, where EO represents ethylene oxide and PO represents propylene oxide.

Suitable biocides are for example commercially obtainable as Proxel brands. Examples which may be mentioned are: 1,2-benzisothiazolin-3-one (BIT) (commercially obtainable as Proxel® brands from Avecia Lim.) and its alkali metal salts; other suitable biocides are 2-methyl-2H-isothiazol-3-one (MIT) and 5-chloro-2-methyl-2H-isothiazol-3-one (CIT).

In one embodiment of the present invention, the printing formulation used in step (A) comprises up to 30% by weight of auxiliary (e), based on the sum total of metal powder (a), binder (b), emulsifier (c) and if appropriate rheology modifier (d).

In one embodiment of the present invention, step (A) comprises printing uniformly with a printing formulation comprising at least one metal powder (a). In another embodiment, a pattern of metal powder (a) is printed by printing substrate and particularly textile with printing formulation comprising metal powder (a) at some places and not in other places. Preference is given to printing patterns wherein metal powders (a) are arranged on a substrate and particularly textile in the form of straight or preferably bent stripy patterns or line patterns, wherein the lines mentioned may have for example a breadth and thickness each in the range from 0.1 μm to 5 mm and the stripes mentioned may have for example a breadth in the range from 5.1 mm to for example 10 cm or if appropriate more and a thickness in the range from 0.1 μm to 5 mm.

One advantageous embodiment of the present invention comprises printing stripy patterns or line patterns of metal powder (a) wherein the stripes and lines, respectively, neither touch nor intersect. Very particular preference is given to printing such patterns as constitute an interdigital structure. The stripes or lines therein can have a minimum separation in the range from 2 to 3 mm.

In one embodiment of the present invention, printing in step (A) is effected by various processes which are known per se. One embodiment of the present invention utilizes a stencil through which the printing formulation comprising metal powder (a) is pressed using a squeegee. The process described above is a screen printing process. Useful printing processes further include gravure printing processes and flexographic printing processes. A further useful printing process is selected from valve-jet processes. Valve-jet processes utilize printing formulation comprising preferably no thickener (d1).

The process of the present invention is carried out by depositing in step (B) a further metal on the surface of substrate and particularly the textile sheet material. Here the reference to “textile sheet material” is to be understood as referring to the textile previously processed in step (A).

Two or more further metals can be deposited in step (B), but it is preferable to deposit just one further metal.

In one embodiment of the present invention, carbonyl iron powder is chosen as metal powder (a) and silver, gold and especially copper as further metal.

In one embodiment of the present invention, hereinafter also referred to as step (B1), no external source of voltage is used in step (B1) and the further metal in step (B1) has a more strongly positive standard potential in the electrochemical series of the elements, in alkaline or preferably in acidic solution, than the metal underlying metal powder (a) and than hydrogen.

One possible procedure is for substrate, and particularly textile, processed in step (A) and in step (B) to be treated with a basic, neutral or preferably acidic preferably aqueous solution of salt of further metal and if appropriate one or more reducing agents, for example by placing it into the solution in question.

One embodiment of the present invention comprises treating in step (B1) in the range from 0.5 minutes to 12 hours and preferably up to 30 minutes.

One embodiment of the present invention comprises treating in step (B1) with a basic, neutral or preferably acidic solution of salt of further metal, the solution having a temperature in the range from 0 to 100° C. and preferably in the range from 10 to 80° C.

One or more reducing agents may be additionally added in step (B1). When, for example, copper is chosen as further metal, possible reducing agents added include for example aldehydes, in particular reducing sugars or formaldehyde as reducing agent. When, for example, nickel is chosen as further metal, examples of reducing agents which can be added include alkali metal hypophosphite, in particular NaH₂PO₂.2H₂O, or boranates, in particular NaBH₄.

In another embodiment, hereinafter also referred to as step (B2), of the present invention, an external source of voltage is used in step (B2) and the further metal in step (B2) can have a more strongly or more weakly positive standard potential in the electrochemical series of the elements in acidic or alkaline solution than the metal underlying metal powder (a). Preferably, carbonyl iron powder may be chosen for this as metal powder (a) and nickel, zinc or in particular copper as further metal. In the event that the further metal in step (B2) has a more strongly positive standard potential in the electrochemical series of the elements than hydrogen and than the metal underlying metal powder (a) it is observed that additionally further metal is deposited analogously to step (B1).

Step (B2) may be carried out for example by applying a current having a strength in the range from 10 to 100 A and preferably in the range from 12 to 50 A.

Step (B2) may be carried out for example by using an external source of voltage for a period in the range from 1 to 60 minutes.

In one embodiment of the present invention, step (B1) and step (B2) are combined by initially operating without and then with an external source of voltage and the further metal in step (B) having a more strongly positive standard potential in the electrochemical series of the elements than the metal underlying metal powder (a).

One embodiment of the present invention comprises adding one or more auxiliaries to the solution of further metal. Examples of useful auxiliaries include buffers, surfactants, polymers, in particular particulate polymers whose particle diameter is in the range from 10 nm to 10 μm, defoamers, one or more organic solvents, one or more complexing agents.

Acetic acid/acetate buffers are particularly useful buffers.

Particularly suitable surfactants are selected from cationic, anionic and in particular nonionic surfactants.

As cationic surfactants there may be mentioned for example: C₆-C₁₈-alkyl-, -aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the gemini surfactant N,N′-(lauryldimethyl)ethylenediamine dibromide.

Examples of suitable anionic surfactants are alkali metal and ammonium salts of alkyl sulfates (alkyl radical: C₈ to C₁₂), of sulfuric acid monoesters of ethoxylated alkanols (degree of ethoxylation: 4 to 30, alkyl radical: C₁₂-C₁₈) and of ethoxylated alkylphenols (degree of ethoxylation: 3 to 50, alkyl radical: C₄-C₁₂), of alkylsulfonic acids (alkyl radical: C₁₂-C₁₈), of alkylarylsulfonic acids (alkyl radical: C₉-C₁₈) and of sulfosuccinates such as for example sulfosuccinic mono- or diesters. Preference is given to aryl- or alkyl-substituted polyglycol ethers and also to substances described in U.S. Pat. No. 4,218,218, and homologs with y (from the formulae of U.S. Pat. No. 4,218,218) in the range from 10 to 37.

Particular preference is given to nonionic surfactants such as for example singly or preferably multiply alkoxylated C₁₀-C₃₀ alkanols, preferably with three to one hundred mol of C₂-C₄-alkylene oxide, in particular ethoxylated oxo process or fatty alcohols.

Suitable defoamers are for example siliconic defoamers such as for example those of the formula HO—(CH₂)₃—Si(CH₃)[OSi(CH₃)₃]₂ and HO—(CH₂)₃—Si(CH₃)[OSi(CH₃)₃][OSi(CH₃)₂OSi(CH₃)₃], nonalkoxylated or alkoxylated with up to 20 equivalents of alkylene oxide and especially ethylene oxide. Silicone-free defoamers are also suitable, examples being multiply alkoxylated alcohols, for example fatty alcohol alkoxylates, preferably 2 to 50-tuply ethoxylated preferably unbranched C₁₀-C₂₀ alkanols, unbranched C₁₀-C₂₀ alkanols and 2-ethylhexan-1-ol. Further suitable defoamers are fatty acid C₈-C₂₀-alkyl esters, preferably C₁₀-C₂₀-alkyl stearates, in each of which C₈-C₂₀-alkyl and preferably C₁₀-C₂₀-alkyl may be branched or unbranched.

Suitable complexing agents are such compounds as form chelates. Preference is given to such complexing agents as are selected from amines, diamines and triamines bearing at least one carboxylic acid group. Suitable examples are nitrilotriacetic acid, ethylenediaminetetraacetic acid and diethylenepentaaminepentaacetic acid and also the corresponding alkali metal salts.

One embodiment of the present invention comprises depositing sufficient further metal as to produce a layer thickness in the range from 100 nm to 100 μm and preferably in the range from 1 μm to 10 μm.

Step (B) is carried out by metal powder (a) being in most cases partially or completely replaced by further metal, and the morphology of further deposited metal need not be identical to the morphology of metal powder (a).

In one embodiment of the process of the present invention, a thermal treatment can be carried out following (B), in one or more steps. To carry out two or more steps for thermal treatment, two or more steps can be carried out at the same temperature or preferably at different temperatures. The thermal treatment after step (B) can be carried out similarly to the thermal treatment described above for after step (A).

Step (C) of the process of the present invention comprises applying a formulation comprising carbon in the form of carbon black or preferably carbon nanotubes or more preferably in the form of graphene uniformly. Here “uniformly” is to be understood as meaning over the entire area or in wide regions, for example in stripes at least 1 cm wide and preferably in stripes at least 2 cm wide.

The applying can be effected with a doctor blade for example. Other possible forms of applying are screen printing, for example as rotary printing, or flat bed printing, and/or padding of a textile.

One embodiment of the present invention comprises applying uniformly a formulation, preferably an aqueous formulation, comprising carbon in the form of carbon black or preferably in the form of graphene.

In one embodiment of the present invention, a formulation is applied uniformly that comprises carbon in the form of carbon black, for example oven black or lamp black, preferably flame black, thermal black, acetylene black, more particularly furnace black.

One advantageous embodiment of the present invention comprises uniformly applying a formulation comprising carbon nanotubes (CNTs), for example single-walled carbon nanotubes (SWCNTs) and preferably multi-walled carbon nanotubes (MWCNTs).

Carbon nanotubes are known per se. A method of making them and properties are described for example by A. Jess et al. in Chemie Ingenieur Technik 2006, 78, 94-100.

In one embodiment of the present invention, carbon nanotubes have a diameter in the range from 0.4 to 50 nm and preferably in the range from 1 to 25 nm.

In one embodiment of the present invention, carbon nanotubes have a length in the range from 10 nm to 1 mm and preferably in the range from 100 nm to 500 nm.

Carbon nanotubes are obtainable by following processes known per se. For example, a volatile carbonaceous compound such as for example methane or carbon monoxide, acetylene or ethylene, or a mixture of volatile carbonaceous compounds such as for example synthesis gas can be decomposed in the presence of one or more reducing agents such as for example hydrogen and/or a further gas such as for example nitrogen. Another suitable gas mixture is a mixture of carbon monoxide with ethylene. Suitable temperatures for decomposition are for example in the range from 400 to 1000° C. and preferably in the range from 500 to 800° C. Suitable pressure conditions for decomposition are for example in the range from atmospheric pressure to 100 bar, preferably to 10 bar.

Single- or multi-walled carbon nanotubes are obtainable for example by decomposing carbonaceous compounds in an arc, in the presence or absence of a decomposition catalyst.

One embodiment comprises decomposing volatile carbonaceous compound or compounds in the presence of a decomposition catalyst, for example Fe, Co or preferably Ni.

It is particularly preferable for carbon in step (C) to comprise graphene. Graphene for the purposes of the present invention comprises a carbon polymorph comprising essentially sp²-hybridized carbon atoms in layers about one to 500 carbon atoms in thickness.

One embodiment of the present invention comprises selecting graphene from graphene materials that has a length and width each in the range from 10 nm to 1000 μm and a thickness in the range from 0.3 nm to 1 μm, preferably in the range from 1 to 50 nm and more preferably to 5 nm.

In one embodiment of the present invention, graphene is selected from graphene materials which have an atom ratio of carbon:noncarbon atoms in the region of 50:1, preferably 100:1, more preferably 200:1 and even more preferably 500:1. The noncarbon atoms are alike or different and essentially selected from oxygen, sulfur, nitrogen, phosphorus and hydrogen, preferably sulfur and oxygen and particularly hydrogen. The fraction of noncarbon atoms is essentially determined by the method of making the graphene in question.

In one embodiment of the present invention, graphene is selected from graphene materials obtainable by mechanical or chemical exfoliation (removal of leaf-shaped particles, removal of one or more layers, preferably up to 500 carbon monolayers) of graphite.

In another embodiment of the present invention, graphene is selected from graphene materials obtainable by partial oxidation of graphite to graphite oxide, mechanical exfoliation and subsequent reduction.

In another embodiment of the present invention, graphene is selected from graphene materials obtainable by expansion of graphite or graphite intercalation compounds with alkali metal, hydrogen peroxide, halogen or butyllithium, for example n-butyllithium, followed by exfoliation of layers.

Exfoliation herein is to be understood as meaning removal of leaf-shaped particles or removal of one or few layers, preferably 2 up to 1000, more preferably 3 up to 500 carbon monolayers.

In one embodiment of the present invention, graphene has an electrical conductivity in the range from 1 to 200 Ω, preferably 15 to 40 Ω. This conductivity is determined for example over the entire coated surface, for example over the entire layer after step (C).

One embodiment of the present invention comprises applying in step (C) a preferably aqueous formulation, for example by blade coating, printing, spraying, padding or laminating, preference being given to blade coating and printing. The aqueous formulation comprises carbon black, carbon nanotubes and/or graphene.

One embodiment of the present invention comprises applying in step (C) an aqueous formulation comprising from 1 to 300 g of carbon black, carbon nanotubes and/or graphene/kg of formulation, preferably from 30 to 60 g/kg.

One embodiment of the present invention comprises applying in step (C) aqueous formulation comprising in addition to carbon black and/or carbon nanotubes or graphene at least one additive, for example one or more dispersants (g), one or more rheology modifiers, fixers or emulsifiers.

In one embodiment of the present invention, aqueous formulation used in step (C) may comprise at least one binder (b).

Examples of suitable dispersants are condensation products of aromatic mono- or disulfonic acids with one or more aldehydes, particularly with formaldehyde, as free acids or particularly as alkali metal salt. A preferred example of dispersants are condensation products of naphthalenesulfonic acid with formaldehyde, in the form of the potassium or sodium salt.

In one embodiment of the present invention, dispersant (g) in aqueous formulation of the present invention may be wholly or partly replaced by one or more emulsifiers (c).

In one embodiment of the present invention, aqueous formulation used in step (C) comprises altogether from 0.5% to 20% by weight of additives, preferably from 1% to 15% by weight.

One embodiment of the present invention comprises applying in step (C) from 1 to 50 g of carbon black, carbon nanotubes and/or graphene per m² of surface area of substrate, particularly of textile.

In one embodiment of the present invention, a thermal treatment can be carried out after the application of carbon black or carbon nanotubes or particularly graphene. Conditions for a thermal treatment are described above.

When the deposition of further metal and application of carbon in the form of carbon black, nanotubes or preferably graphene is complete, substrate metallized according to the present invention and, more particularly, metallized textile sheet material according to the present invention is obtained. Substrate metallized according to the present invention and, more particularly, metallized textile sheet material according to the present invention may additionally be rinsed one or more times, for example with water.

To produce such textile sheet materials as are to be used for example for producing electrically heatable auto seats, power cables can additionally be attached to the ends in a conventional manner, for example by soldering.

In one advantageous embodiment of the present invention, step (C) is followed by at least one further step selected from
(D) applying a corrosion-inhibiting layer, or
(E) applying a flexible layer,
   the corrosion-inhibiting layer being rigid, for example nonbendable, or flexible.

Suitable corrosion-inhibiting layers include for example layers composed of one or more of the following materials: waxes, particularly polyethylene waxes, varnishes, for example waterborne varnishes, 1,2,3-benzotriazole and salts, particularly sulfates and methosulfates of quaternized fatty amines, for example lauryl/myristyl-trimethylammonium methosulfate.

Examples of flexible layers are foils, in particular polymeric foils, for example of polyester, polyvinyl chloride, thermoplastic polyurethane (TPU) or especially polyolefins such as for example polyethylene or polypropylene, the terms polyethylene and polypropylene each also comprehending copolymers of ethylene and propylene respectively.

Another embodiment of the present invention comprises applying as flexible layer a binder (b), which may be the same as or different from any printed binder (b) from step (B).

The applying may in each case be effected by laminating, adhering, welding, blade coating, printing, spraying or casting.

When a binder has been applied in step (E), a thermal treatment may again be carried out subsequently.

The present invention further provides a metallized sheet material, more particularly a metallized textile sheet material, comprising
at least one textile substrate,
at least one layer of a further metal applied in a pattern, preferably in an interdigital pattern, and
at least one layer, comprising carbon in the form of carbon black or preferably graphene.

The present invention further provides metallized sheet materials or substrates and, more particularly, metallized textile sheet materials obtainable by the process described above. Metallized sheet materials in accordance with the present invention are not just obtainable in an efficient and specific manner in that for instance the flexibility and electrical conductivity for example can be influenced in a specific manner through the type of printed pattern of metal powder (a) and through the amount of deposited further metal for example. Metallized sheet materials in accordance with the present invention are also versatile in use, for example in applications for electrically conductive textiles.

In one embodiment of the present invention, metallized sheet materials which are in accordance with the present invention and have been printed with a line or stripy pattern have a specific resistance in the range from 1 mΩ/cm² to 1 MΩ/cm² or in the range from 1 μΩ/cm to 1 MΩ/cm, measured at room temperature and along the stripes or lines in question.

In one embodiment of the present invention, metallized sheet materials which are in accordance with the present invention and have been printed with a line or stripy pattern comprise at least two leads secured in a conventional manner, for example soldered, to the respective ends of lines or stripes.

The present invention further provides for the use of metallized sheet materials which are in accordance with the present invention for example for producing heatable textiles, in particular heatable auto seats and heatable carpets, wall coverings and apparel.

The present invention further provides for the use of metallized textile sheet materials which are in accordance with the present invention as or for producing such textiles as convert current into heat, further such textiles as are able to screen natural or artificial electric fields, textile-integrated electronics and RFID textiles. RFID textiles are for example textiles able to identify a radio frequency, for example with the aid of a device known as transponder or RFID tag. Such devices do not require an internal source of current.

Examples of textile-integrated electronics are textile-integrated sensors, transistors, chips, light-emitting diodes (LEDs), solar modules, solar cells and Peltier elements. Sensors such as in particular textile-integrated sensors are suitable for example for monitoring the bodily functions of infants or older people. Suitable applications further include high-conspicuity clothing such as high-conspicuity vests for example.

The present invention therefore provides processes for producing heatable textiles, for example heatable wall coverings, carpets and drapes, heatable auto seats and heatable carpets, further for producing such textiles as convert current into heat and further such textiles as are able to screen electric fields, textile-integrated electronics and RFID textiles using metallized sheet materials which are in accordance with the present invention. Processes in accordance with the present invention for producing heatable textiles, such textiles as convert current into heat, further such textiles as are able to screen electric fields and RFID textiles using metallized textile sheet materials which are in accordance with the present invention can be carried out for example by subjecting metallized textile sheet material which is in accordance with the present invention to a process of making up.

The present invention specifically provides heatable auto seats produced using metallized textile which is in accordance with the present invention. Heatable auto seats of the present invention require for example little current to generate a pleasant seat temperature and therefore are gentle on the automotive battery, and this is advantageous in winter in particular. It is further possible to use the process of the present invention to produce heatable auto seats having a flexible design, and this ensures a comfortable distribution of heat. Metallized textiles of the present invention have excellent properties even after prolonged use, for example not many hot spots.

The present invention specifically provides wall coverings, carpets and drapes produced using or consisting of metallized textile which is in accordance with the present invention.

The present invention further provides aqueous formulations comprising graphene,
(d) at least one rheology modifier, preferably selected from thickeners, and
(g) at least one dispersant,
   and optionally at least one binder (b).

Rheology modifiers and dispersants are described above.

In one embodiment of the present invention, dispersant (g) in aqueous formulation of the present invention may be wholly or partly replaced by one or more emulsifiers (c).

In one embodiment of the present invention, aqueous formulations of the present invention comprise
from 0.01% to 5% by weight, preferably from 0.1% to 3.5% by weight and more preferably from 2% to 3% by weight of graphene,
optionally from 0.1% to 20% by weight preferably 4% to 8% by weight of rheology modifier (d) and
optionally from 0.1% to 10% by weight, preferably 1% to 6% by weight of dispersant.

### BRIEF DESCRIPTION OF THE DRAWINGS

FIG. 1 is a schematic image of stripy pattern of a woven polyester fabric.

The invention is elucidated by working examples.

### WORKING EXAMPLES

### General Comments:

Percentages are by weight, unless expressly indicated otherwise.

Parts by weight of comonomer in the binder are always based on total solids.

Amounts in g in the case of dispersions are always reported gross.

### I. Production of Print Pastes

### Ingredients:

metal powder (a.1): carbonyl iron powder, d₁₀ 3 μm, d₅₀ 4.5 μm, d₉₀ 9 μm, passivated with a microscopically thin layer of iron oxide
graphene: length nm, diameter nm.
   binder (b.1): aqueous dispersion, pH 6.6, solids content 44.8% by weight, of a random emulsion copolymer of
1 part by weight of glycidyl methacrylate, 1 part by weight of acrylic acid, 28.3 parts by weight of styrene, 59.7 parts by weight of n-butyl acrylate, 10 parts by weight of 2-hydroxyethyl acrylate, weight average particle diameter 150 nm, determined by Coulter Counter, T_{g}: −19° C., dynamic viscosity (23° C.) 70 mPa·s
   binder (b.2):
aqueous dispersion, pH 7.9, solids content 40%, of a polyurethane constructed from hexamethylene diisocyanate and polyester diol prepared by polycondensation of adipic acid, 1,6-hexanediol and neopentyl glycol (molar fractions 1:0.8:0.2), OH number 55 mg KOH/g to DIN 53240 and the sodium salt of 2′-aminoethyl-2-aminoethanesulfonic acid
weight average particle diameter 100 nm, determined by Coulter Counter, T_{g}: −47° C., dynamic viscosity (23° C.) 45 mPa·s
   additives:
(e.1): thickener: random copolymer of acrylic acid (92% by weight), acrylamide (7.6% by weight), methylenebisacrylamide, quantitatively neutralized with ammonia (25% by weight in water), molecular weight M_{w} about 150 000 g/mol, in a water-in-white oil emulsion, solids content 27%.
(e.2): thickener: 51% by weight solution of a reaction product of hexamethylene diisocyanate with n-C₁₈H₃₇(OCH₂CH₂)₁₅OH in isopropanol/water (volume fractions 2:3)
(e.3) fixer (melamine-formaldehyde condensate, etherified with ethylene glycol)
(f.1): compound of 2,2′,2″-nitrilotris[ethanol] with 4-[(2-ethylhexyl)amino]-4-oxoisocrotonic acid (1:1) (content (W/W): 30%), dissolved in: 2,2′,2″-nitrilotriethanol
dispersant (g.1): condensation product of naphthalenesulfonic acid and formaldehyde, completely neutralized with NaOH.

### 1.2 Production of a Print Paste Comprising Metal Powder (a)

The following were stirred together:
54 g of water
700 g of metal powder (a.1).
125 g of binder (b.1)
10 g of fixer (e.3)
20 g of emulsifier (c.1)
20 g of thickener (e.2)
20 g of corrosion inhibitor (f.1)

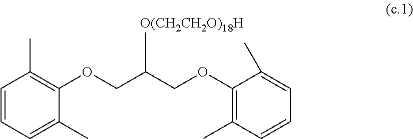

Stirring was done for 20 minutes at 5000 rpm (Ultra-Thurrax) to obtain a print paste having a dynamic viscosity of 80 dPa·s at 23° C., measured using a Haake rotary viscometer.

An aqueous print paste (A.1) was obtained.

### II. Production of an Inventive Formulation Comprising Graphene

The following were mixed together in a stirred vessel:
100 g of an aqueous graphene formulation comprising
3 g of graphene,
60 g of binder (b.2),
8 g of thickener (e.1),
2 g of fixer (e.3),
a further 27 g of binder (b.3),
4.1 g of dispersant (g.1).

An inventive formulation was obtained.

### III. Printing of Textile, Step (A), and Thermal Treatment

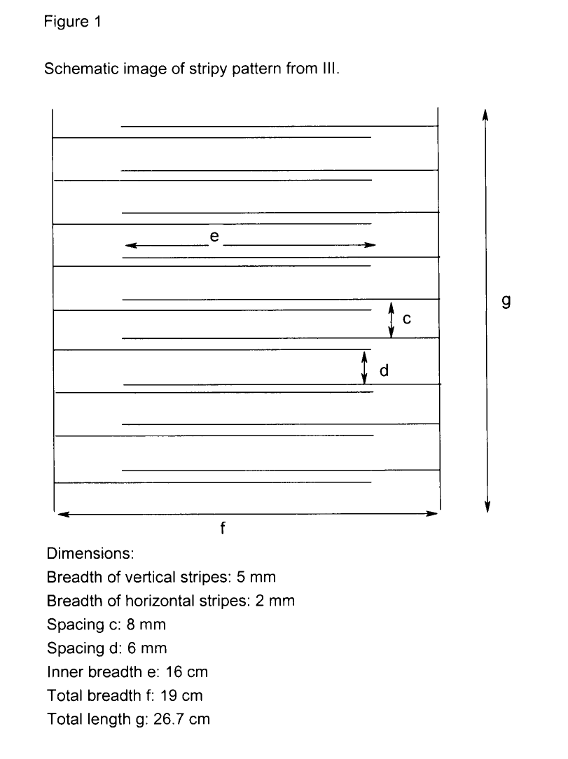

The print paste of 1.2 was used to print a woven polyester fabric using an 80 mesh screen with a stripy pattern. The pattern can be found in FIG. 1 as a schematic illustration.

This was followed by drying in a drying cabinet at 100° C. for 10 minutes and curing at 150° C. for 5 minutes to obtain a printed and thermally treated woven polyester fabric.

### IV. Depositing a Further Metal, Step (B), and Applying a Further Layer, Step (C)

IV.1 Depositing Copper without External Source of Voltage

Printed and thermally treated woven polyester fabric from II. was treated for 30 minutes in a bath (room temperature) having the following composition:
1.47 kg of CuSO₄.5 H₂O
382 g of H₂SO₄
5.1 l of distilled water
1.1 g of NaCl
5 g of C₁₃/C₁₅-alkyl-O-(EO)₁₀(PO)₅—CH₃
(EO: CH₂—CH₂—O, PO: CH₂—CH(CH₃)—O)

The woven polyester fabric was removed, rinsed twice under running water and dried at 90° C. for 15 minutes.

Metallized polyester fabric PES-1 was obtained.

### IV.2 Applying a Layer Comprising Graphene

The metallized polyester fabric PES-1 was printed with the formulation from II. uniformly between and across the conductor tracks on a printing table using a screen-printing stencil and a squeegee.

The fabric thus printed was dried at 80° C. for 10 minutes and subsequently cured at 150° C. for 5 minutes.

This gave a metallized fabric which is in accordance with the present invention and where, following application of an electric voltage, the area printed with inventive formulation comprising graphene became heated up, for example to about 50° C. in the case of 14.3 V. No hot spots were observed, however, only a uniform heating up.

We claim:

1. A process for producing a metallized surface, which process comprises
(A) applying a formulation comprising at least one metal powder (a) as a component patternedly or uniformly,
(B) depositing a further metal on the textile surface,
(C) applying a further layer comprising carbon in the form of carbon black or carbon nanotubes or graphene.

2. The process according to claim 1 wherein the formulation used in step (A) comprises:
(a) at least one metal powder,
(b) at least one binder,
(c) at least one emulsifier,
(d) optionally at least one rheology modifier.

3. The process according to claim 1 or claim 2 wherein a printing formulation comprising at least one metal powder (a) is applied in step (B) by printing.

4. The process according to any one of claims 1 to 3 wherein carbon in step (C) is selected from graphene.

5. The process according to any one of claims 1 to 4 wherein one or more thermal treatment steps (D) are carried out following step (A), (B) or (C).

6. The process according to any one of claims 1 to 5 wherein said metal powder (a) is obtained by thermal decomposition of iron pentacarbonyl.

7. The process according to any one of claims 1 to 6 wherein no external source of voltage is used in step (C) and the further metal in step (C) has a more strongly positive standard potential in the electrochemical series of the elements than the metal underlying metal powder (a).

8. The process according to any one of claims 1 to 6 wherein an external source of voltage is used in step (C) and the further metal in step (C) has a more strongly or more weakly positive standard potential in the electrochemical series of the elements than the metal underlying metal powder (a).

9. The process according to any one of claims 1 to 8 wherein one or more articles needing or generating electric current are fixed to the surface following step (B).

10. The process according to any one of claims 1 to 9 wherein patterns in step (B) are selected from interdigital structures.

11. The process according to any one of claims 1 to 10 wherein step (C) is followed by at least one further step selected from
(D) applying a corrosion-inhibiting layer, and
(E) applying a flexible layer,
the corrosion-inhibiting layer being flexible or rigid.

12. The process according to any one of claims 1 to 11 wherein a textile surface is concerned.

13. A metallized surface obtainable by following a process according to any one of claims 1 to 12.

14. The use of a metallized textile surface according to claim 13 as or for producing a textile that converts current into heat, a textile able to screen an electric field, a textile-integrated electronic system, a display means, a roof liner of vehicles and a textile able to generate current.

15. A textile that converts current into heat, a textile able to screen an electric field, a textile-integrated electronic system, a display means, a roof liner of vehicles or a textile able to generate current, produced using a metallized textile surface according to claim 13.

16. A metallized sheet material comprising
at least one substrate,
at least one layer of a further metal applied in a pattern, and
at least one layer, comprising carbon in the form of carbon black or carbon nanotubes or graphene.

17. An aqueous printing formulation comprising graphene,
(d) at least one rheology modifier, and
(g) at least one dispersant.
